(19) United States
(12) Patent Application Publication
(10) Pub. No.: US 2005/0160793 A1
(43) Pub. Date: Jul. 28, 2005

(54) Sensor element, in particular a planar gas sensor element

(76) Inventors: Bernd Schumann, Rutesheim (DE); Ulrich Eisele, Stuttgart (DE)

Correspondence Address: KENYON & KENYON, ONE BROADWAY, NEW YORK, NY, 10004, US

(21) Appl. No.: 10/504,942

(22) PCT Filed: Dec. 3, 2002
(86) PCT No.: PCT/DE02/04412

(30) Foreign Application Priority Data
Feb. 16, 2002 (DE) 102 06 497.0

(51) Int. Cl. G01N 27/406

(52) U.S. Cl. 73/31.05; 73/25.05; 204/424

(57) ABSTRACT

A sensor element, in particular a planar gas sensor element, having a sensor structure is described, which is heatable by a heater structure. A first spacer layer is provided between the heater structure and the sensor structure, the spacer layer having a first recess in the area of the heater structure into which a first inlay, which electrically insulates the heater structure from the sensor structure, is inserted.

### FIELD OF THE INVENTION

The present invention relates to a sensor element, in particular a planar gas sensor element, such as a lambda probe or a nitrogen oxide sensor, that includes a solid electrolyte and a heater structure.

### BACKGROUND INFORMATION

Planar gas sensor elements (“lambda probes”), may be heated using a heating device having a heater structure that is incorporated into a multilayer ceramic layer structure. A main function of the heating is to stabilize the sensor element signal. German Published Patent Application No. 199 06 908 (the '908 application) describes a heater structure designed as a platinum resistance conductor in a meandering pattern between two ceramic layers in the hot area of the gas sensor element, i.e., in the area in which the measuring and reference electrodes are situated, and which is exposed to the gas to be analyzed.

In the case of ceramic gas sensor elements based on a solid electrolyte made substantially of zirconium dioxide, it is also necessary to electrically insulate the heater structure from the ionic conductors, i.e., solid electrolytes, provided in the area of the actual sensor structure. To do so, either a printed heater structure as described in the '908 application is embedded between two layers of aluminum oxide, likewise printed, and having a thickness of approximately 20 μm to 50 μm, or the heating device is sintered or glued over the entire area of one side of a sensor element having a heater structure already embedded between two ceramic films.

One disadvantage of these two methods, however, is the mechanical stresses which occur in the sensor element during operation and/or manufacture and are caused mainly by differences in the thermal expansion coefficients of the materials used as well as the comparatively great heat flow to the side of the sensor element facing away from the sensor structure.

An object of the present invention is to provide a sensor element having a heater structure having the lowest possible capacitive electric coupling to the respective sensor structure and/or the ionic conductor, i.e., solid electrolyte, used there. In addition, an object of the present invention is also to supply the heat generated by the heater structure to the sensor structure as much as possible while at the same time preventing mechanical stresses within the sensor element.

### SUMMARY OF THE INVENTION

The sensor element according to the present invention has the advantage over the related art that the heater structure has only a low capacitive coupling electrically with respect to the sensor structure so that the actual sensor function is virtually unimpaired electrically by the heater structure apart from the desired heating effect.

In addition, the design of the sensor element according to the present invention achieves the result that mechanical stresses within the sensor element are suppressed as much as possible and the sensor structure situated in the vicinity of the heater structure is heated effectively and rapidly by the heater structure.

The hot area of the heater structure may be inserted between two electrically insulating inlays, which are preferably made of aluminum oxide. In this way the hot area of the heater structure is integrated into the sensor element, and the electrically insulating inlays together with the heater structure form an insulation body surrounded completely or partially by other layers of the sensor element, usually composed essentially of zirconium dioxide.

Electrically insulating intermediate layers may be provided between the insulation body formed by the electrically insulating inlays and the heater structure embedded therein and the adjacent zirconium dioxide layers to counteract shrinkage of the two layers during sintering, by having the electrically insulating inlay be composed of aluminum oxide and the adjacent layer be composed of zirconium dioxide.

With regard to the desired reduction in capacitive coupling, it is also advantageous when the electrically insulating inlay and the provided second inlay each have a thickness of 100 μm to 1000 μm, e.g., 200 μm to 500 μm.

The first spacer layer may lateral surround the first recess, which accommodates the electrically insulating first inlay, in the form of a closed frame. The second spacer layer may also laterally surround the second recess accommodating the second inlay, again in the form of a closed frame. This forms an insulation body composed of the inlays and the heater structure embedded therein, the entirety being completely enclosed by the substrate, the frame-like spacer layers in some areas, and an additional zirconium dioxide layer that may be provided between the insulation body and the actual sensor structure.

Intermediate layers may be provided between the inlay and the adjacent layer. These may be composed of zirconium dioxide, and may have a low sintering activity and may have a low sinter density so that they remain porous after sintering and may act as stress equalizing layers. Alternatively, one or both intermediate layers may also be designed as mechanical stress-absorbing layers, which entails a sufficient adhesion and cohesion between the inlay and the intermediate layer, on the one hand, and between the intermediate layer and the side of the intermediate layer facing away from the inlay on the other hand. In the case of the stress-equalizing layer, a magnesium aluminum spinel, such as MgAl₂O₄, or barium hexaaluminate has proven especially suitable as the material for the intermediate layer, or in the case of the stress-absorbing layer, a mixture of zirconium dioxide and aluminum oxide has proven particularly suitable.

The desired low capacitive coupling is further enhanced by having the thickness of the electrically insulating first inlay and also the thickness of the optional second layer comparatively large due to the intermediate layers without resulting in deformations or cracks in the sensor element during manufacture, sintering, or operation, or at alternating temperatures, due to the lower thermal expansion of aluminum oxide in comparison with zirconium dioxide.

Comparative measurements have shown that the measures described above make it possible to reduce capacitive coupling by a factor of at least 5 to 10.

It is also advantageous that improved heat transfer from the heater structure into the sensor structure is achievable in that the rear area of the sensor element in the area of the inlays. The side of the sensor element laterally opposite the heater lead wire is surrounded by the spacer layers designed as a frame. The zirconium dioxide, which has poor thermal conductivity, provided in this rear area thus prevents unwanted heat dissipation. Moreover, this rear area may now have a lateral extension, as defined by the width of the frame, of significantly greater than 300 μm, e.g., 500 μm to 2000 μm, thereby also contributing to the reduction in heat dissipation.

To further improve the heat transfer from the heater structure in the direction of the sensor structure, it is advantageous when the second inlay on the side of the heater structure facing away from the sensor structure has a porosity or a porous void structure created in particular with the help of a pore forming agent in the course of a sintering operation used in the manufacture of the sensor element. Alternatively or additionally, the second inlay may also be provided with cubical, cylindrical, or lenticular milled-out areas or recesses.

It is also frequently advantageous when the electrically insulating first inlay used on the side of the heater structure facing the sensor structure has a porosity or porous void structure created using a pore forming agent and/or when the first inlay has cubical, cylindrical or lenticular recesses, for example. Due to this structure of the first inlay, the heat transfer from the heater structure in the direction of the sensor structure is initially somewhat hindered, but this advantageously further reduces the capacitive input of electric signals from the heater structure into the sensor structure. Moreover, a porosity of the inlays or the provision of recesses therein is generally advantageous in order to reduce mechanical stresses.

To reduce mechanical stresses in the sensor element during manufacture and/or operation, in particular in the case of expansions, it is also advantageous when the first and/or second inlay has at least one recess, which may be a plurality of cuts or slots traversing the inlay in some areas. These may be situated so that when seen from above, they are not above or below an area occupied by the heater structure. To this end, these cuts or slots in the inlays are provided at those locations where the heater structure is not above or below them.

The use of comparatively thick inlays of aluminum oxide that are dense, i.e., not porous, as the first and/or second inlay has the advantage that they result in particularly effective electric insulation of the heater structure with respect to the surrounding zirconium dioxide layers and this also prevents platinum from diffusing from the heater structure into the layers. Moreover, inlays of aluminum oxide are comparatively good thermal conductors, which improves the effective heating of the sensor structure.

It is also advantageous when the inserted first inlay and/or the second inlay has a beveled edge as seen from above at least in the area of the transition from the hot area of the heater structure into the cold area of the heater lead wire, these bevels may be directed in opposite directions in the case that the edge of the first inlay and the edge of the second inlay are both beveled. The bevels thus define, as seen from above, an overlap area in which there is a transition from the heater structure to the heater lead wires. Beveling the edges of the inlays prevents the development and propagation of cracks in the inlays due to mechanical stresses.

### BRIEF DESCRIPTION OF THE DRAWINGS

FIG. 1 shows a first exemplary embodiment of a sensor element according to the present invention having an embedded heater area above which there is a sensor structure.

FIG. 2 shows a longitudinal section of FIG. 1 in the heater area as seen from above.

FIG. 3 shows a second exemplary embodiment of a sensor element according to the present invention.

FIG. 4 shows another exemplary embodiment of a sensor element according to the present invention.

FIG. 5 shows an inlay of aluminum oxide having lenticular recesses.

FIG. 6 shows an inlay of aluminum oxide having a cubical recess.

### DETAILED DESCRIPTION

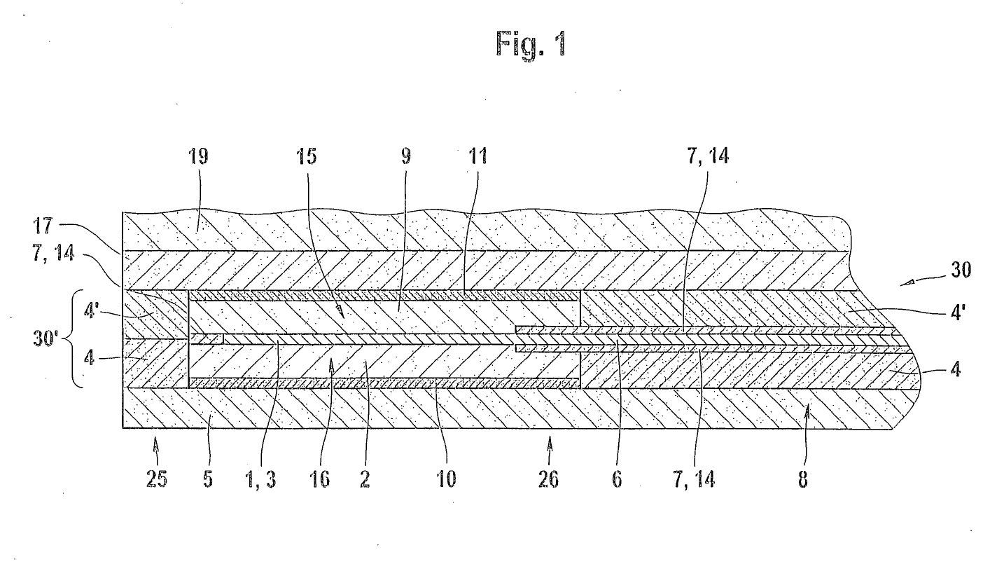

FIG. 1 shows a sensor element 30 having a sensor structure 19 and a heater area 30′. With regard to the production of sensor element 30 according to FIG. 1, known techniques are used, i.e., ceramic green films onto which other layers are printed as needed, then stacked, laminated and finally sintered to form sensor element 30.

FIG. 1 shows in detail a sintered ceramic sensor element 30 in the form of a planar gas sensor element having a solid electrolyte including a bottom layer or a substrate 5 of zirconium dioxide on which there is a second intermediate layer 10 in some areas, printed onto the ceramic green film that forms substrate 5 at the time of its manufacture. A second spacer layer 4 of zirconium dioxide is also provided and forms a lower frame, thus defining a trough-shaped second recess 16 into which a second inlay 2 is placed after the printing of second intermediate layer 10 and deposition of second spacer layer 4 onto substrate 5. In the example described here, second inlay 2 is electrically insulating following the sintering operation that concludes the manufacture of sensor element 30, and it has a thickness of 200 μm to 500 μm. During manufacture, it is first inserted as a ceramic green film using an aluminum oxide ceramic and is then converted into an aluminum oxide ceramic by sintering in conjunction with the other components of sensor element 30.

Then a heater structure 1 in the form of a platinum resistance conductor is applied, such as by printing, to some areas of second spacer layer 4 and second inlay 2. The area above second inlay 2 defines a hot area 3 of sensor element 30. In addition, conventional heater lead wires 6, which run on second spacer layer 4 and are also formed, for example, by printed platinum conductors, are provided. Heater lead wires 6 run in a cold area 8 of sensor element 30 and are separated from second spacer layer 4 and second inlay 2, respectively, by an insulation layer 7, which may also be printed and is situated beneath heater lead wire 6. To achieve a reliable connection of second spacer layer 4 and second inlay 2 with insulation layer 7, a transition material 14 is provided in the area of insulation layer 7, which is composed of a mixture of aluminum oxide and zirconium dioxide, for example, and may form a partial layer of insulation layer 7, so that insulation layer 7 and second inlay 2 and spacer layer 4, respectively, are reliably and fixedly joined together.

FIG. 1 also shows that an insulation layer 7 and a transition material 14 are also provided in some areas on the side of heater structure 1 facing away from heater lead wire 6 to achieve an electric insulation of heater structure 1 from second spacer layer 4 and first spacer layer 4′, respectively, the first spacer layer being positioned above the second spacer layer and being explained below. Heater structure 1 has a wave-form design in the example explained here.

A first spacer layer 4′, which may have a similar design and is situated on second spacer layer, is also made of zirconium dioxide, for example, and is also designed in the form of a closed frame. This first spacer layer 4′ defines a first recess 15 into which a first inlay 9 of aluminum oxide ceramic is inserted. Then a first intermediate layer 11 is also applied over the entire area of first inlay 9 by printing it in the course of manufacturing onto first inlay 9, which is initially in the form of a ceramic green film. The composition of first intermediate layer 11 may correspond to the composition of second intermediate layer 10. The composition of first inlay 9 may be the same as the composition of second inlay 2, i.e., after sintering it may also composed of an aluminum oxide ceramic.

On the whole, first spacer layer 4′, second spacer layer 4 and first inlay 9 enclosed by it laterally, second inlay 2 and first intermediate layer 11 as well as second intermediate layer 10 define heater area 30′, the thickness of first intermediate layer 11 and second intermediate layer 10 being selected so that together with inlays 2, 9 and heater structure 1, they completely and evenly seal recesses 15, 16 in spacer layers 4, 4′.

According to FIG. 1, an insulation layer 7 having a transition material 14 is also situated on heater lead wire 6 so that heater lead wire 6 is also enclosed by insulation layer 7 and transition material 14 and is thus electrically insulated with respect to spacer layers 4, 4′ and in some areas also with respect to inlay 2, 9.

Another layer 17, which may be a zirconium dioxide layer, is provided over the entire area of first spacer layer 4′, and then the sensor structure 19 is constructed on this layer so that sensor structure 19 is heatable by heater structure 1.

The design described here achieves the result that heater structure 1, which is enclosed on both sides by directly adjacent inlays 2, 9, is electrically insulated with respect to sensor structure 19 via first inlay 9, so that capacitive coupling is largely suppressed.

The thickness of first inlay 2 and/or second inlay 9 is between 200 μm and 500 μm. The thickness of first intermediate layer 11 and/or second intermediate 10 is 5 μm to 50 μm, e.g., 10 μm to 30 μm.

The first and/or second intermediate layer 10, 11 is used mainly to absorb or equalize mechanical stresses between first inlay 9 and additional layer 17 and between second inlay 2 and substrate 5 that occur during sintering in the course of manufacturing sensor element 30. Therefore, first and/or second intermediate layer 10, 11 has a low sintering activity during sintering with respect to the adjacent inlay and substrate 5 or additional layer 17, and does not sinter to a dense form, i.e., it remains porous, or first and/or second intermediate layer 10, 11 becomes fused to adjacent inlay 9 and adjacent additional layer 17 and adjacent second inlay 2 and adjacent substrate 5, respectively, in this sintering process.

With regard to the composition of first and/or second intermediate layer 10, 11, it is advantageous when it contains at least one element selected from the group of aluminum, magnesium, zirconium or barium. Both first and second intermediate layer 10, 11 may be composed either of a magnesium aluminum spinel, such as MgAl₂O₄, barium hexaaluminate, or a mixture of zirconium dioxide and aluminum oxide.

The lateral extension of second recess 16 filled by second inlay 2 and first recess 15 filled by first inlay 9 is may be large enough to cover the area taken up by hot area 3 of heater structure 1 as seen from above.

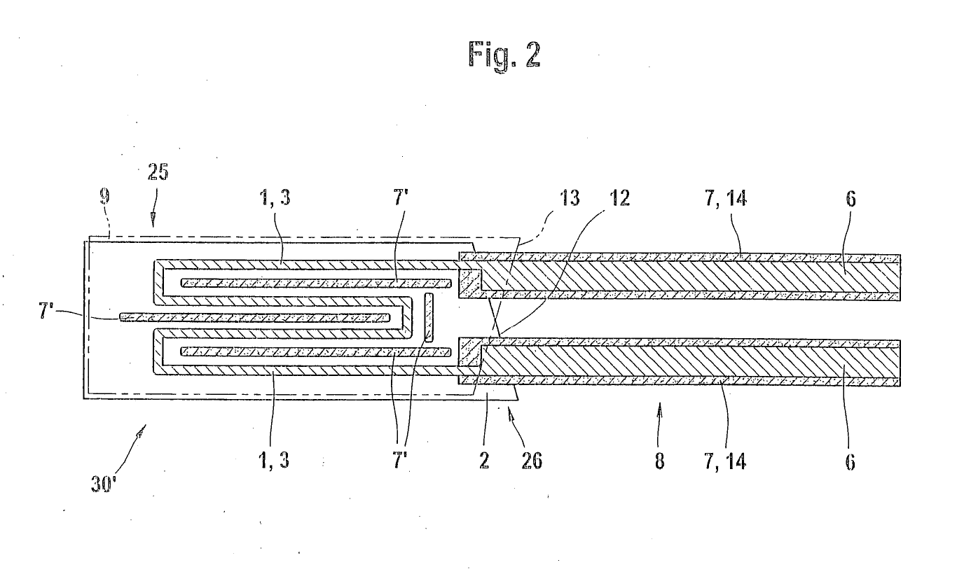

FIG. 2 shows a longitudinal section of FIG. 1 in heater area 30′. This shows only heater structure 1, heater lead wire 6 including insulation layer 7, which is located beneath it, and transition material 14, as well as second inlay 2 which is above or below heater structure 1 in hot area 3 and first inlay 9. This shows clearly the meandering structure of heater structure 1 in hot area 3 and comparatively wide heater lead wire 6 in comparison with the width of the actual heater structure 1, which is designed in the form of a platinum resistance conductor.

In a continuation of FIG. 1, FIG. 2 also shows that first inlay 9 and second inlay 2 also each have a beveled edge 12, 13, as seen from above, in an overlap area 26, which also defines a transition from hot area 3 to cold area 8, the bevels of these two edges 12, 13 being directed in opposite directions to one another. The shape of first recess 15 in first spacer layer 4′ is therefore designed according to the shape of first inlay 9 and the shape of second recess 16 in second spacer layer 4 is designed according to the shape of second inlay 2 according to FIG. 2.

FIG. 2 shows that second inlay 2 and/or first inlay 9 may optionally have recesses 7′ in the form of slots or cuts. These recesses 7′ are situated in such a way that they are not above or below an area covered by heater structure 1 as seen from above. FIG. 2 also clearly shows a rear area 25 formed by first spacer layer 4′ and second spacer layer 4 beneath the first spacer layer. This rear area 25 is much wider than 300 μm, e.g., 500 μm to 2000 μm.

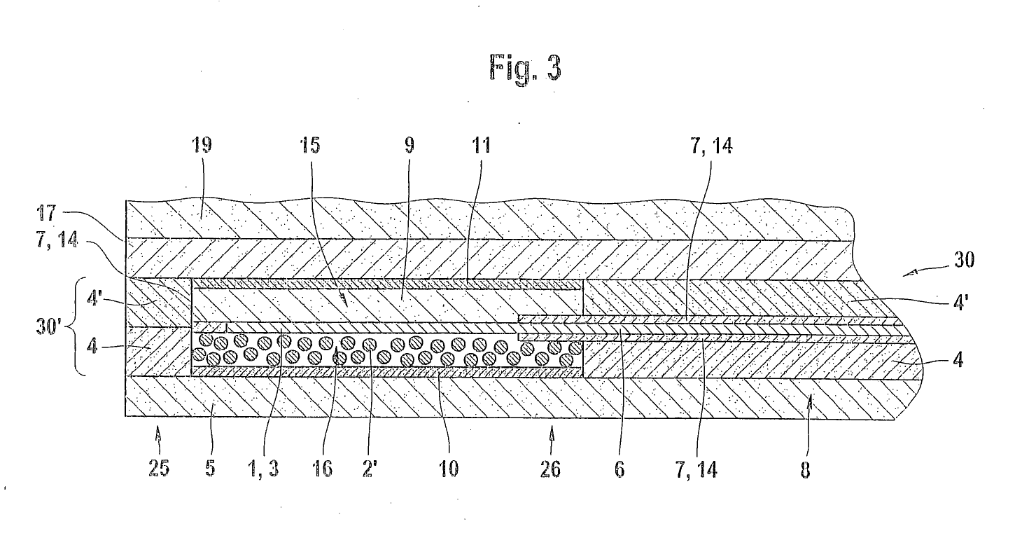

FIG. 3 illustrates an exemplary embodiment of a sensor element 30 as an alternative to that in FIG. 1 or the variant according to FIG. 2, second inlay 2 being designed as a second inlay having a porous void structure 2′ to better absorb, i.e., dissipate, mechanical stresses in this way. The porous void structure is achieved by first adding an additional pore forming agent to the ceramic green film, which is designed as an inlay or intarsia, and which forms the second inlay having a hollow structure 2′ after sintering, so that in the course of the sintering process, second inlay 2′ develops a porous void structure. Pore forming agents suitable for this purpose, such as carbon black particles or glass carbon particles, are known from the related art.

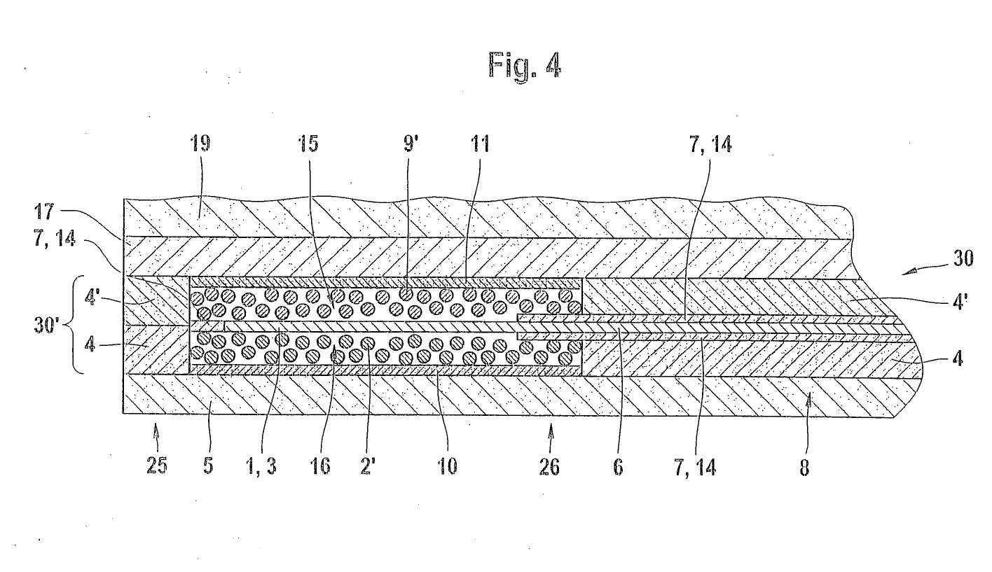

In a continuation of FIG. 3, FIG. 4 illustrates another exemplary embodiment of a sensor element 30, first inlay 9 also being designed in the form of a first inlay having a porous void structure 9′. The second inlay having a porous void structure 2′ is designed in FIG. 4 according to FIG. 3. This achieves the result that the capacitive coupling of heater structure 1 in the area of sensor structure 19 is further reduced and mechanical stresses are further reduced or better absorbed or dissipated. However, the produced hollow structure may result in the heat transfer from heater structure 1 into the area of sensor structure 19 being less effective.

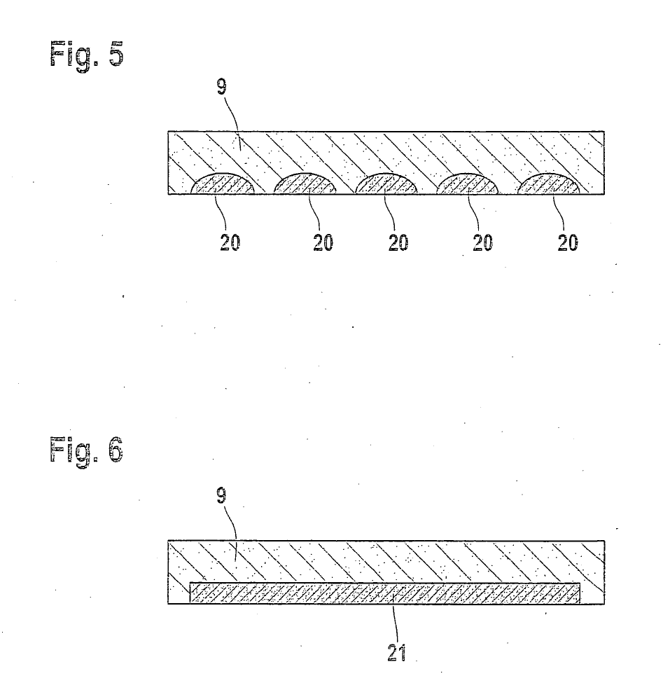

FIGS. 5 and 6 illustrate other exemplary embodiments of first inlay 9, second inlay 2 also being able to be designed in the same way. In particular, FIG. 5 shows how first inlay 9 is provided with lenticular recesses 20, preferably on the side of inlay 9 facing heater structure 1, instead of the porous void structure according to FIG. 4. Otherwise inlay 9 is again composed of aluminum oxide ceramic. Lenticular recesses 20 are created for example via corresponding milling of the ceramic green film used initially to manufacture first inlay 9. According to FIG. 6 a cubical recess, i.e., milled-out area 21, is provided.

1-16. (canceled)

17. A planar gas sensor element comprising:
a heater structure;
a sensor structure heatable by the heater structure; and
a first spacer layer situated between the heater structure and the sensor structure;
wherein the first spacer layer includes a first recess proximal to the heater structure and a first inlay inserted into the first recess, the first inlay electrically insulating the heater structure from the sensor structure.

18. The sensor element of claim 17, further comprising:
a substrate situated on a side of the heater structure facing away from the sensor structure; and
a second spacer layer situated between the heater structure and the substrate;
wherein the second spacer layer includes a second recess proximal to the heater structure and a second inlay inserted into the second recess, the second inlay electrically insulating the heater structure from the substrate.

19. The sensor element of claim 18, wherein the first and the second recess have approximately the same dimensions and are positioned approximately in a stacked arrangement, and wherein the heater structure is positioned between the first inlay and the second inlay.

20. The sensor element of claim 18, wherein at least one of the first and second inlay is a ceramic film.

21. The sensor element of claim 20, wherein the ceramic film includes one of an aluminum oxide film and a film convertible into an aluminum oxide film by sintering, the aluminum oxide film having a thickness of 100 μm to 1000 μm.

22. The sensor element of claim 21, wherein the aluminum oxide film has a thickness of 200 μm to 500 μm.

23. The sensor element of claim 18, wherein at least one of:
a) the first spacer layer surrounds the first recess laterally in the form of a closed frame; and
b) the second spacer layer surrounds the second recess laterally in the form of a closed frame.

24. The sensor element of claim 18, wherein the first spacer layer and the second spacer layer are situated one above the other, and the heater structure separates the first inlay from the second inlay in at least one area.

25. The sensor element of claim 18, further comprising:
at least one heater lead wire;
at least one insulating layer, the insulating layer insulating the at least one heater lead wire from the first and second spacer layers; and
an additional layer;
wherein the substrate, the first spacer layer, the second spacer layer and the additional layer enclose the first and second inlays and the heater structure with the exception of the at least one heater lead wire and the at least one insulating layer.

26. The sensor element of claim 25, further comprising:
a) first intermediate layer configured to provide electric insulation, situated between the first inlay and the additional layer in at least one area; and
b) a second intermediate layer configured to provide electric insulation, situated between the second inlay and the substrate in at least one area.

27. The sensor element of claim 26, wherein the first intermediate layer is configured to at least one of absorb and equalize mechanical stresses between the first inlay and the additional layer, and wherein the second intermediate layer is configured to at least one of absorb and equalize mechanical stresses between the second inlay and the substrate.

28. The sensor element of claim 27, wherein the mechanical stresses are associated with at least one of sintering and a change in temperature during operation.

29. The sensor element of claim 26, wherein at least one of:
the first recess is filled completely and evenly with one of i) the first inlay and ii) the first inlay and the first intermediate layer; and
the second recess is filled completely and evenly with one of i) the second inlay and ii) the second inlay and the second intermediate layer.

30. The sensor element of claim 25, wherein at least one of the first inlay and the second inlay includes a beveled edge in an area where a hot region of the heater structure transitions to a cold area of the heater lead wire.

31. The sensor element of claim 30, wherein in the case where both the first inlay and the second inlay include a beveled edge, the bevels are directed in opposite directions.

32. The sensor element of claim 26, wherein at least one of the first and the second intermediate layers includes one of the following:
i) at least one element selected from the group of Al, Mg, Zr and Ba;
ii) an Mg—Al spinel;
iii) barium hexaaluminate; and
iv) a mixture of zirconium oxide and aluminum oxide.

33. The sensor element of claim 32, wherein the Mg—Al spinal is MgAl₂O₄.

34. The sensor element of claim 25, wherein the first spacer layer, the substrate, the second spacer layer and the additional layer include zirconium oxide.

35. The sensor element of claim 18, wherein the first spacer layer surrounds the first recess in the form of a closed frame, and the second spacer layer surrounds the second recess in the form of a closed frame, each closed frame having a width greater than 300 μm, and wherein a rear area of a heater area is formed by the first and second spacer layers.

36. The sensor element of claim 25, wherein the width of each closed frame is between 500 μm and 2000 μm.

37. The sensor element of claim 18, wherein at least one of the the first inlay and the second inlay has a porous structure formed using a pore forming agent in the course of a sintering process and one of a cubical, cylindrical and lenticular milled-out area.

38. The sensor element of claim 18, wherein at least one of the first inlay and the second inlay has at least one of a recess, a cut and a slot that is not vertically aligned with an area covered by the heater structure.
